(19) United States
(12) Patent Application Publication
(10) Pub. No.: US 2005/0237763 A1
(43) Pub. Date: Oct. 27, 2005

(54) Light dispersing device

(76) Inventor: William Paul Swanson, Gainesville, FL (US)

Correspondence Address: William Paul Swanson, 3621 SW 18th Street, Gainesville, FL, 32608, US

(21) Appl. No.: 10/828,805

(22) Filed: Apr. 22, 2004

(51) Int. Cl. F21V 7/04; F21S 4/00

(52) U.S. Cl. 362/551

(57) ABSTRACT

A light-visible electromagnetic radiation or luminous flux-dispersing device, that distributes light that has been introduced into it. Device consisting of a rod of constant cross section made of optically transparent material with sides polished to a finish of optical transparency, which is structurally bent at one or many locations along the length of the rod to a radius of curvature and to a number of radians per curve, curve or curves lying in one plane or in three dimensions, thereby presenting light within the device an angle of incidence which allows the transmittance of light from within the interior of the device to the exterior.

### BACKGROUND OF THE INVENTION

Many systems, or luminaires, have been devised to provide general illumination for the interiors of human occupied or used dwellings and buildings including homes and offices. These systems have the purpose of providing illumination for general usage of a home or business, without which the interior space would be unsuitable for performing the typical functions of that space.

Systems have been developed that utilize optical tubes to transport light from a source to the area to be lighted. The science of optics are well known and understood. These devices distribute the light introduced into them either by conveying the light introduced into one end through the optical tube and out the other end or through modifying the surface characteristics along the length of the optical tube such as changing the texture of the surface or by the introduction of varying materials to the surface of the tube thereby facilitating the dispersion of light along the length of the tube. This last system does not maintain an optically transparent surface.

### BRIEF SUMMARY OF THE INVENTION

This invention is intended to be used for the general illumination of an interior space in the function of a table lamp or a floor lamp, but it could also be attached to a wall.

This invention is an optical tube of constant cross section, consisting of a single homogenous material, with the exception of possibly one mirrored end, with an optically transparent surface, intended to disperse light which has been introduced into it into the interior space of a building filled with normal atmospheric air. This dispersion is accomplished by having formed this tube along it's longitudinal axis into curves or spirals of a small enough radius of curvature that these curves or spirals present light traveling inside the tube with the necessary angle of incidence to allow transmittance of the light to the outside of the tube, thereby dispersing light that was once interior to the tube to the outside of the tube. These curves or spirals could be singular or plural and intermittently spaced or continuous along the length of the optical tube. These curves or spirals could lie in one plane or they could be curved in three dimensions. These curves or spirals could have an amount of curvature of any number of radians greater than zero.

The amount of light that is dispersed from a curve, or bend, depends on the radius of the curvature. Not all of the light that is in the tube can or will be dispersed from one bend unless one bend is continuous enough in length to allow this. It is the intention of this device to utilize the curve or curves to allow the escapement of all light from the tube. The amount of curvature and the number of curves can be infinitely adjusted to accomodate the amount of light dispersed from any given length of optical tube. If there is still some luminous flux contained within the tube after the flux reaches the far end, said far end could be made to function as a mirror through one of many available processes, thereby reflecting the remaining flux back along the tube to be dispersed as it encounters bends. Or light from a second source could be introduced into the second end of the tube to provide the same function as the first light source.

### DETAILED DESCRIPTION OF THE INVENTION

This device consists of an acrylic rod, but it could be made of any other polymers or glass, which is as transparent to visible light as is possible to obtain. This rod maintains a dimensionally constant cross section along the length of its longitudinal axis. Device dimensions could range from 5/8 inch in diameter to 1½ inches in diameter and from 1 foot in length to 8 feet in continuous length but it could perform in other dimensional forms, as well as square, rectangular, triangular or other cross sectional forms. This rod could be obtained through either an extrusion process or a casting process. Circumferential surfaces are to be polished so as to be optically transparent.

One end of this rod is intended to receive luminous flux, or light, from any source that could include an array of light emitting diodes, or any other source of light. If desired the second end of the rod could also have light introduced into it. The manner of creation of this light is immaterial. The introduction of the light into the rod, or optical tube, is accomplished by simply directing the flow of photons from said source toward one or both ends of the optical tube, the end or ends having been polished to optical transparency, thereby allowing the entrance of the photons into the tube. The end or ends of the tube would be cut in a plane perpendicular to the longitudinal axis of the tube and would be flat but they could be optimized in shape to permit the maximum attainment of light introduction possible.

This rod would have one or multiple curves or bends along its length. These bends could be introduced by heating and then bending the rod to the desired curvature or the rod could be cast from molten plastic or glass and allowed to cool with the desired bends in the cast shape. The amount of curvature of any curve could be any number of radians greater than zero. The amount of curvature and the number of curves is infinitely adjustable to obtain the amount of light dispersion desired.

Light that has been introduced into the rod will travel along the rods length and behave according to known optical principles. Upon encountering a bend or curvature in the structural shape of the rod some of the light will have the required angle of incidence to travel through the surface and enter the room. Light that does not leave the tube at this bend will be conveyed through the tube to the next curvature at which point the process repeats itself. The number and the radius and the quantity of radians of the curves encountered by the light would be controlled to allow the escapement of light contained in the tube, either in one pass through the length of the tube or by reflecting the light back along the tube from the far end of its introduction and thereby dispersing any light remaining after the first pass through another pass through the dispersing curves. Or any light remaining in the tube after the first pass through the tube could be directed into another light dispersing device or it could be allowed to leave the tube and enter the room, although this device is not intended to be a spotlight, such light as leaving the end being merely incidental to the task of general illumination.

This invention differs from other similar appearing devices in several ways. It is not intended as merely a light conduit though it must perform some light conduction to effect its purpose. It is not intended to simulate neon light tubes nor is it intended to function as a means of communicating words or language or as a billboard or advertising device. Other optical tubes are designed to disperse the light contained within them by changing the characteristics of the surface of the tube by either mechanically altering the surface such as with sandpaper or by altering the refractive index of the surface such as with the addition of another material. These last devices do not maintain a homogenous, optically transparent surface for dispersing the light nor do they rely on the shape of the structure of the tube to effect the dispersion of the light.

1) A device consisting of a rod of optically transparent material, of any cross-sectional shape but of constant cross-sectional dimensions along its length, with the surface along its length being polished so as to be optically transparent, which is bent structurally in one or several locations along its length in a plane or in three dimensions, to radii and amounts of curvature that facilitate the escapement of some or all of any light that was introduced into the tube through one or both of its ends, to function as a table lamp or a floor lamp, but it could be hung an a wall.
